(19) United States
(12) Patent Application Publication
(10) Pub. No.: US 2006/0213801 A1
(43) Pub. Date: Sep. 28, 2006

(54) Film packaged product portion and method for producing the same

(76) Inventors: Ipek Karaoren, Izmir (TR); Berthold Schreck, Dusseldorf (DE); Matthias Reimann, Dusseldorf (DE); Ingrid Kraus, Dusseldorf (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/400,313

(22) Filed: Apr. 7, 2006

Related U.S. Application Data
(63) Continuation-in-part of application No. PCT/EP04/10707, filed on Sep. 24, 2004.

(30) Foreign Application Priority Data
Oct. 7, 2003 (DE) 103 46 386.0
Oct. 7, 2003 (DE) 203 15 364.2

(51) Int. Cl. B65D 85/00; B32B 27/00

(52) U.S. Cl. 206/524.7; 206/524.1

(57) ABSTRACT

The invention relates to a package formed from at least two films, containing product portions, in particular washing, cleaning and/or care products, which are released when the package is opened, by dissolution or disintegration of at least one film. The package comprises at least one compartment for receiving the product. At least one film of the package is substantially plastically reshaped in order to provide a compartment to receive the product. The disintegration and/or dissolving times of the package measured in distilled water at a temperature of 10° C. are less than similar times for a conventional film package made, for example of a Mono-Sol-M-8630 or an equivalent film measured under the same conditions. The improved disintegration and/or dissolving time may be enhanced by providing a striated surface structure and/or small holes whose diameter ranges from 1 μm to 50 μm.

### CROSS REFERENCE TO RELATED APPLICATIONS

This application is a '365 (c) continuation in part application of PCT/EP2004/010707 filed Sep. 24, 2004, which in turn claims priority to DE Application 103 46 386.0 filed Oct. 7, 2003 and DE Application 203 15 364.2 filed Oct. 7, 2003, each of the foregoing applications is incorporated herein by reference.

### FIELD OF THE INVENTION

The present invention relates to a film-packaged product portion, especially to a washing, cleaning and/or care product portion, to a process for its production and to its use as a laundry detergent, cleaning composition, care composition, hair treatment composition, hair dyeing composition, medicament, crop protection composition, food, cosmetic, fertilizer, building material, adhesive, bleach, disinfectant and/or fragrancing composition.

### BACKGROUND OF THE INVENTION

Film-packaged product portions, especially washing, cleaning and/or care product portions, have been known for some time from the prior art. A disadvantage of these product portions is that they typically have insufficient film solubility, an insufficiently high dissolution rate and/or an insufficiently short disintegration rate.

There are numerous processes for producing such film-packaged product portions, in particular washing, cleaning and/or care product portions. For instance, EP-A1-1,161,587 describes a process for producing a water-soluble package comprising the steps of:
placing a first sheet of film over a forming die having at least one cavity;
heating the film to mold the film into the at least one cavity thereby forming at least one recess in the film;
placing a composition in the at least one formed recess; and
sealing a second sheet of film across the at least one formed recess to produce at least one closed package, at least one cavity being cooled.

EP-A1-1,161,370 describes a process for producing a water-soluble package, comprising the steps of:
placing a first sheet of film over a forming die having at least one forming cavity; heating the film;
molding the film in the at least one cavity thereby forming at least one recess in the film;
placing a composition in the at least one formed recess; and
sealing a second sheet of film across the at least one formed recess to form at least one closed package,
   the composition being in the form of a liquid or of a gel, and, once formed, the at least one recess substantially being retained in its formed orientation by the application of a vacuum through the cavity.

EP-A1-1,161,369 describes a process for producing a water-soluble package, comprising the steps that:
a first sheet of film is placed over a forming die having at least one cavity;
the film is heated;
the film is pressed or molded into the at least one cavity thereby forming at least one recess in the film;
a composition is placed in the at least one formed recess, and
a second sheet of film is sealed across the at least one formed recess to produce at least one closed package,

the second film being heated by a heating plate having at least one concave depression which, in use, overlies the at least one cavity, the heating step involving the step of bringing the film into intimate contact with the at least one depression.

EP-A1-1,161,368 describes a process for producing a water-soluble package, comprising the steps of:
placing a first sheet of film over a forming die having at least one cavity;
heating the film;
molding the film into the at least one cavity thereby forming at least one recess;
placing a composition in the at least one formed recess; and
sealing a second sheet of film across the at least one formed recess to produce at least one closed package,
the cavity in the forming die having a curved edge, at least a portion of the curved edge being formed from a resiliently deformable material, by means of which the film is molded into the recess.

Further processes for producing water-soluble packages, known as Apouches@, are described in WO-A1-02/060758; WO-A1-02/16207; WO-A1-02/16205; WO-A1-01/83669 and in WO 00/55069, which are fully incorporated here by reference.

The water-soluble packages produced by the known processes have the disadvantageous features of insufficient film solubility, insufficiently high dissolution rate and/or high disintegration rate, or insufficiently low dissolution time and/or disintegration time.

Other disadvantages are that the films of such water-soluble packages known in the prior art have too low a modulus of elasticity, a very low tensile strength and/or low elongation at break, which leads, especially in the case of thin film packages, readily to mechanical damage such as crack formation and the like, for example during transport and/or in the event of inappropriate storage. Moreover, the film packages known in the prior art are frequently not storage-stable, i.e. such films decompose during storage to release the product. In many cases, such films are decomposed by the product present when the packaging film is, for example, not sufficiently alkali-stable and/or moisture-stable.

### SUMMARY OF THE INVENTION

It is an object of the invention to provide a film-packaged product portion or product portions, especially washing, cleaning and/or care product portion(s), comprising at least one compartment for accommodating the product, which have improved film solubility, increased dissolution rate and/or decreased disintegration time.

It has been found that, surprisingly, for example, an inventive film-packaged product portion or product portions, especially washing, cleaning and/or care product portion(s) can have an improved stability, so that the packaging film is not decomposed in the course of normal storage by the product present to release the product, by virtue of the packaging film being configurable so as to be at least sufficiently alkali-stable and/or moisture-stable.

For example, a film-packaged product portion or product portions, especially washing, cleaning and/or care product portion(s), can be provided in which the product portion or product portions are separated spatially from one another and are nevertheless formulated in the same product portion, with the aim of keeping mass transfer and/or mutual impairment, which under some circumstances can be associated with losses of activity, as low as possible. This would also have the advantage that it would be possible to increase the storage stability considerably, especially with regard to the activity of the active components of the washing, cleaning and/or care product portion(s), and also to lower the contents of active substance in individual cases.

It has also been found that, surprisingly, film-packaged product portions, especially washing, cleaning and/or care product portion(s), can be provided with one or more separate compartment(s) which have considerable performance advantages over conventional film-packaged product portions or formulations packaged in pouches, especially with regard to dissolution rate and/or disintegration time.

The invention relates to at least one film-packaged product portion(s), especially washing, cleaning and/or care product portion, comprising at least one compartment for accommodating the product, in which at least one film is alkali-stable and water-soluble and in which at least one film of the film-packaged product portion is substantially plastically reshaped for the purpose of accommodating the product.

The invention relates in particular to at least one film-packaged product portion(s), for example a washing, cleaning and/or care product portion, comprising at least one compartment for accommodating the product, in which at least one film is alkali-stable and water-soluble, and at least one film of the film-packaged product portion, preferably the film package, measured in distilled water at a water temperature of 10° C., having a shorter disintegration time and/or a shorter dissolution time in comparison to a product portion film-packaged by means of a Mono-Sol M-8630 film under otherwise identical conditions, at least one film of the film-packaged product portion being substantially plastically reshaped for the purpose of accommodating the product.

It is essential to the present invention that at least one film of the film package accommodating the product is substantially plastically reshaped, for example thermally and/or by means of vacuum, preferably by means of thermoforming processes. Appropriate processes for reshaping ready-to-use films for the purpose of accommodating a product portion are described in EP-A1-1,161,587; EP-A1-1,161,368; EP-A1-1,161,369; EP-A 1-1,161,370; WO-A1-02/060758; WO-A1-02/16207; WO-A1-02/16205; WO-A1-01/83669 and in WO 00/55069 whose contents are fully incorporated here by reference.

The invention also relates to a film-packaged product portion(s), especially washing, cleaning and/or care product portion, comprising at least one compartment for accommodating the product, wherein at least one film is alkali-stable and water-soluble, and wherein at least one film of the film-packaged product portion, preferably the film packaging, measured in distilled water at a water temperature of 10° C., having
a disintegration time of less than 20 seconds; and/or
a dissolution time of less than 38 seconds,
   at least one film of the film-packaged product portion being substantially plastically reshaped for the purpose of accommodating the product.

The invention further relates to a film-packaged product portion, in which preferably at least one film of the film-packaged product portion, preferentially the films of the film package, measured in distilled water at a water temperature of 10□C, have
a disintegration time of not more than 15 seconds, preferably not more than 10 seconds, preferentially not more than 8 seconds, further preferably not more than 7 seconds, even further preferably of not more than 6 seconds, more preferably of not more than 5 seconds and most preferably of from 1 second to 4 seconds; and/or
a dissolution time of not more than 30 seconds, preferably not more than 25 seconds, preferentially not more than 20 seconds, further preferably not more than 14 seconds, even further preferably of not more than 12 seconds, more preferably of not more than 10 seconds and most preferably of from 1 second to 8 seconds; and
   at least one film of the film-packaged product portion, for the purpose of accommodating the product, is substantially plastically reshaped.

The inventive film-packaged product portion, the film package and/or at least one film of the film package may have a disintegration time of not more than 14 seconds, preferably from 4 seconds to 12 seconds, preferentially from 5 seconds to 11 seconds and more preferably from 6 seconds to 10 seconds.

The invention relates in particular to a film-packaged product portion(s), especially washing, cleaning and/or care product portion, comprising at least one compartment for accommodating the product, wherein at least one film is alkali-stable and water-soluble, at least one film of the film-packaged product portion, preferably the films of the film package, measured in distilled water at a water temperature of 10° C., having
a disintegration time of less than 6 seconds; and/or
a dissolution time of less than 20 seconds; and
   at least one film of the film-packaged product portion is substantially plastically reshaped for the purpose of accommodating the product.

### Definitions

In the context of this invention, substantially plastically reshaped has the definition that a ready-to-use film, for the purpose of accommodating at least one product portion, has been reshaped thermally and/or by means of vacuum while substantially retaining the reshaping with enlargement of the starting surface area of the film.

In the context of this invention, substantially reshaped has the meaning of being stretched greater than 50%.

The formulation “under otherwise identical conditions” means that the inventive film-packaged product portion has been produced under identical conditions to the product portion employed for comparison, with the sole difference that, instead of the inventive film, the comparative film, for example a Mono-Sol M-8630 film or equivalent thereto, of the same thickness, width and length is used.

In the case of a film package comprising a product, the specification of the disintegration time and of the dissolution time relate to a film-packaged product portion with a product filling volume of at least 90%.

The disintegration time and/or dissolution time, unless stated otherwise, relates to a measurement in distilled water at a water temperature of 10° C. and/or 23° C.

The inventive film package comprising at least one compartment is preferably formed from a pot part and a lid part, the lower package part accommodating a product portion being referred to as the “pot” and the upper package part as the “lid”.

When the thickness of the film is of significance for the physical values reported for opening the film-packaged product portion, such as solubility and/or disintegration, such data, unless stated otherwise, relate to a film-packaged product portion with product or without product, the film(s) of the film-packaged product portion having a film thickness of from 1 μm to 50 μm, preferably from 5 μm to 38 μm and/or from 10 μm to 30 μm. The physical values such as solubility and/or disintegration preferably relate to a film-packaged product portion with product or without product, the film of the pot part, at least in the base region, having a thickness of 10 μm±1 and the film of the lid part a thickness of 30 μm±1 or a thickness of 38 μm±1. The physical values such as solubility and/or disintegration more preferably relate to the film(s) which have been used to produce the film package and/or to regions of the film which have the original thickness, i.e. the regions of the film which have not been plastically deformed to produce the film package, based on a film thickness of from 1 μm to 50 μm, preferably from 5 μm to 38 μm and/or from 10 μm to 30 μm, in particular 30 μm or 38 μm.

When the temperature is of significance for the physical values reported for the film-packaged product portion, such data, unless stated otherwise, relate to an ambient temperature of 10° C. and/or 23° C.

When the relative atmospheric humidity (RH) is of significance for the physical values reported for the film-packaged product portion, such data relate, unless stated otherwise, to a relative atmospheric humidity of 50%.

### BRIEF DESCRIPTION OF THE DRAWINGS

The invention is illustrated in detail with reference to the FIGS. 1 to 8 which follow.

FIG. 1 shows the IR spectrum I of the comparative film Mono-Sol M-8630 film by the glossy side

FIG. 2 shows the IR spectrum II of the comparative film Mono-Sol M-8630 film by the matt side;

FIG. 3 shows the IR spectrum III of a film suitable for producing the inventive film package by the glossy side;

FIG. 4 shows the IR spectrum IV of a film suitable for producing the inventive film package by the matt side;

FIG. 5 shows the IR spectrum V of an inventive film package for the lid, glossy interior;

FIG. 6 shows the IR spectrum VI of an inventive film package for the pot, interior;

FIG. 7 shows the IR spectrum VII of an inventive film package for the lid, matt exterior;

FIG. 8 shows the IR spectrum VIII of an inventive film package for the pot, exterior.

FIG. 9 is block diagram illustrating steps of a preferred method for making the Film-packaged Product Portion of the present invention.

FIG. 10 is a perspective illustration of a package made in accordance with the present invention.

FIG. 11 is a sectional view taken on the irregular section line 11-11 of FIG. 10.

FIG. 12 is an enlarged exploded view of the components circled at 12 in FIG. 11, showing an optional feature of the present invention.

FIG. 13 is a fragmentary local sectional view taken on the line 13-13 in FIG. 12, showing a further optional feature of the present invention.

FIG. 14 is a fragmentary local sectional view similar to FIG. 13 showing a different optional feature of the present invention.

### DESCRIPTION OF THE PREFERRED EMBODIMENTS

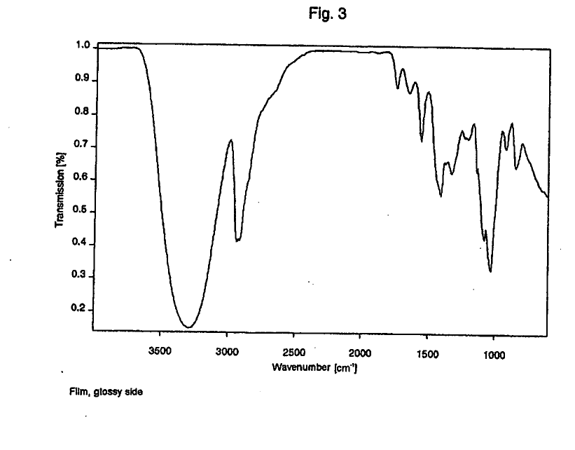

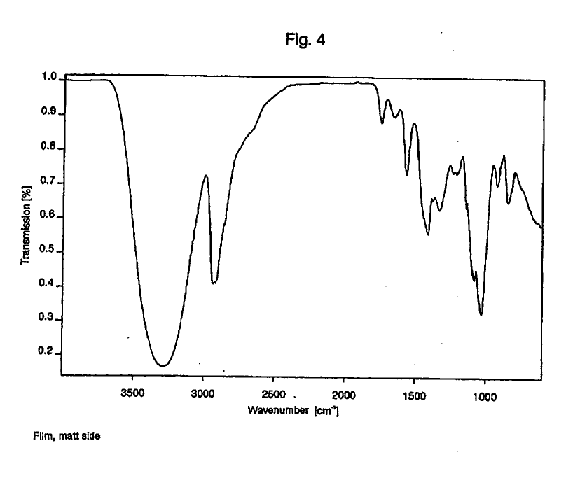

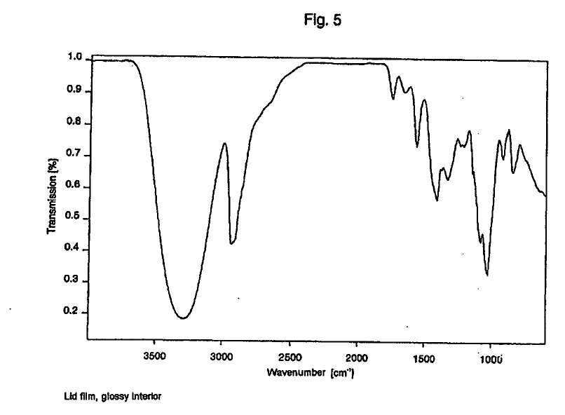

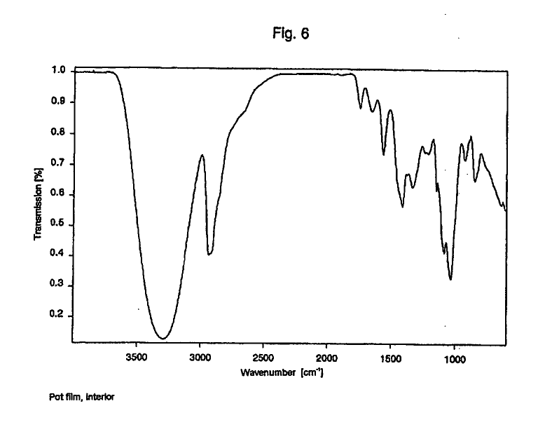

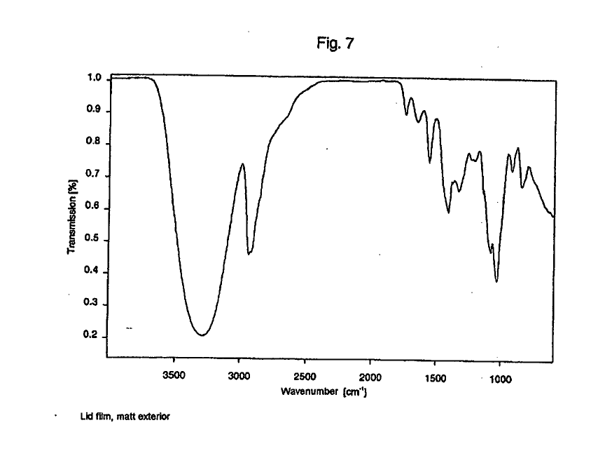

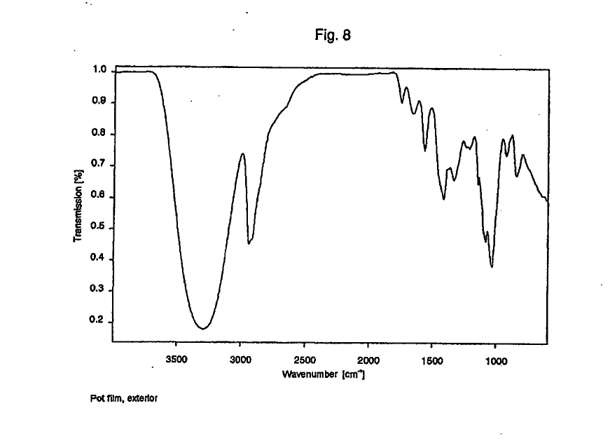

In a preferred inventive embodiment, it is possible for at least one film of the film-packaged product portion, preferably at least one part-surface of the film of the inventive film package, preferentially the lid film, the inner lid film, the outer lid film, the pot film, the outer pot film and/or the inner pot film, to have at least one of the IR spectra III to VIII of FIGS. 3 to 8.

It is particularly preferred when at least one unelongated part-surface of the film of the inventive film package, especially in the region of the outer edges and/or in the edge region, has at least one of the IR spectra III to IV

Physical values of the preferred embodiment, for example, for the disintegration time, the dissolution time, breaking strength, elongation at break, tear propagation resistance and impact resistance are reported below in comparison to the properties of previously-used Mono-Sol M-8630 film.

Mono-Sol M-8630 film is obtainable from Monosol, 1701, Countyline Road; Portage, 46368 Indiana, USA (http//:www.monosol.com). Mono-Sol M-8630 film is an alkali-stable, water-soluble film based on polyvinyl alcohol.

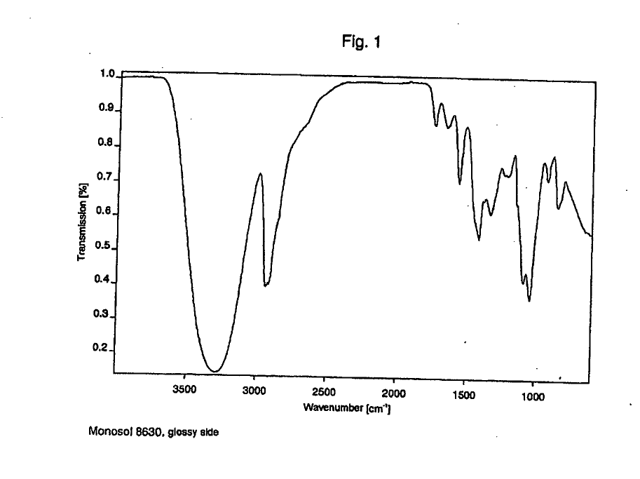

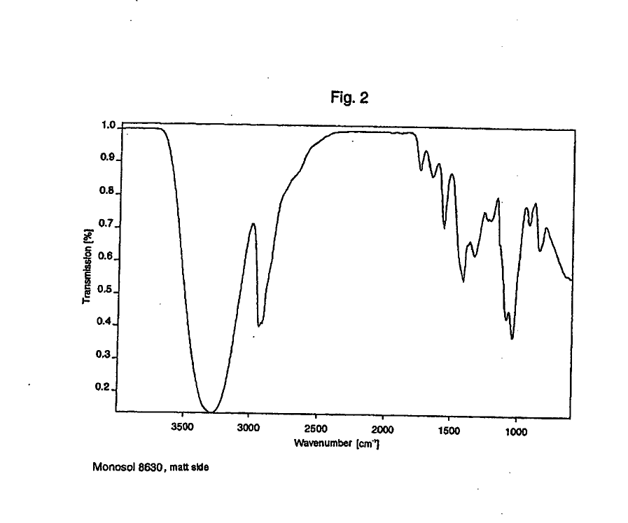

An IR spectrum of the Mono-Sol M-8630 film is given in FIGS. 1 and 2.

According to the product information from Monosol, Mono-Sol M-8630 is stable to alkaline hydrolysis up to a pH of 14. Mono-Sol M-8630 also has a good cold water solubility.

According to the product information from Monosol, a 38 μm Mono-Sol M-8630 film has, at 23° C. and a relative atmospheric humidity of 50% (RH), a breaking strength to ASTM D882, ISO 527 of 4000 psi; a modulus of elasticity, 100% to ASTM D882, ISO 527 of 1500 psi; an elongation at break to ASTM D882, ISO 557 of 465%; a tear propagation resistance to ASTM D1922, ISO-6383 of 1050 g/mil; and an impact resistance to ASTM D1709, DIN 53443 of 800 g.

According to the product information from Monosol, a 38 μm Mono-Sol M-8630 film, in distilled water at 10° C. to MSTM 205, has a disintegration time of 6 seconds and a dissolution time of 20 seconds.

In a preferred embodiment, as shown in FIG. 10, the product P present in the inventive package 21 is released substantially or fully into an aqueous application liquor within no greater than 50 seconds, preferably within no greater than 40 seconds, preferentially within no greater than 30 seconds.

Preference is further given to an embodiment in which the first opening of the film package by dissolution or disintegration of the packaged film for the purpose of release of the product present in the shaped body into an aqueous application liquor proceeds within from 1 to 10 seconds, preferably within from 2 to 8 seconds, preferentially within from 3 to 6 seconds, measured in distilled water at 10° C.

Further embodiments suitable in accordance with the invention for the film package having a film thickness of from 15 μm to 38 μm, preferably of from 20 μm to 30 μm, further preferably of from 22 μm to 25 μm may have a disintegration time of from 1 to 10 seconds, preferably from 2 to 9 seconds and preferentially from 3 to 7 seconds, measured at a water temperature of 10° C.

In addition, embodiments suitable in accordance with the invention for the film package having a film thickness of from 15 μm to 38 μm, preferably of from 20 μm to 30 μm, further preferably of from 22 μm to 25 μm, may have a dissolution time of from 10 to 80 seconds, preferably of from 20 to 70 seconds and preferentially of from 30 to 50 seconds, measured at a water temperature of 10° C. The dissolution time is the time that a film clamped into a slide frame requires to go fully into solution.

In a preferred embodiment of the inventive film-packaged product portion, the film(s) has/have a shorter disintegration time and/or a shorter dissolution time in comparison to the film which has been previously used for film-packaged product portions.

In the embodiment illustrated in FIGS. 10 and 11, the film-packaged product portion 21 has at least one film lid part 23 and/or at least one film pot part 25. The inventive film pot part 25 has a cavity accommodate the product and has a pot-like shape. However, the film pot part may also have a half-shell-like shape, sphere-like shape, a pyramid-like shape or a polygonal shape, for example a polyhedral shape. It is important that the cavity of the pot part formed from at least one film is suitable for accommodating at least some of, preferably all of the product portion. In the present instance, the pot part 25 has a circumferential flange surrounding the cavity which receives the product P. The lid part 23 is bonded to the film of the flange by a sealing seam 29 which extends about the entire circumference of the flange 27.

The inventive film pot part 25 is preferably formed by means of at least one film, preferably of the same material as the film of the lid part 23, but the film of at least one part is substantially reshaped prior to or concurrently with the assembly of the package 21.

It has been found that, surprisingly, the inventive film package with a substantially reshaped film has a distinctly improved disintegration time and/or dissolution time compared to films known in the prior art, especially compared to a Mono-Sol® M-8630 film.

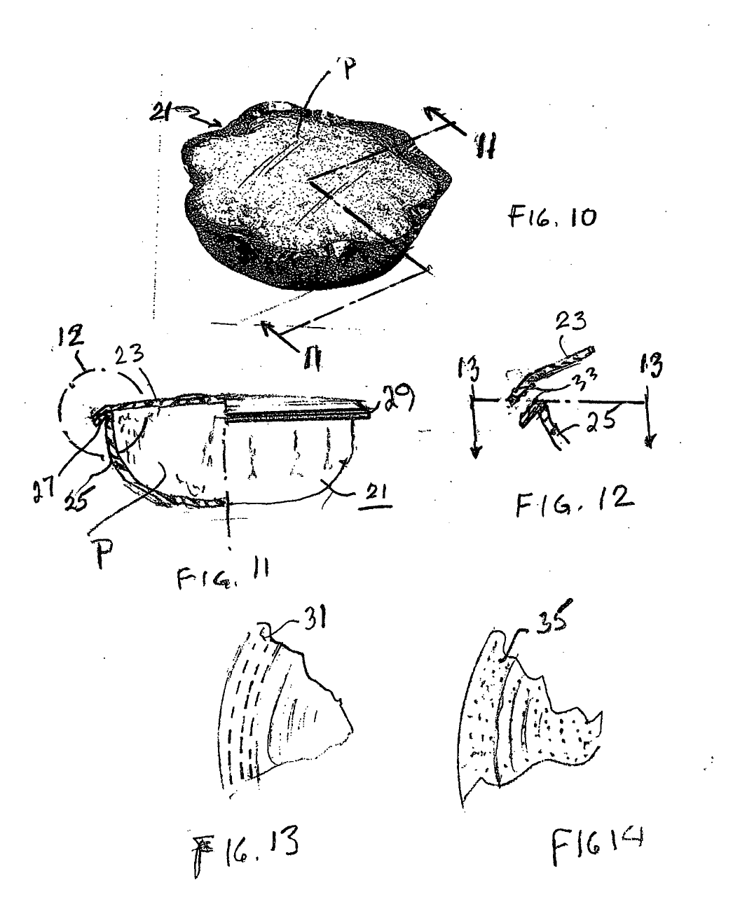

By means of scanning electron micrographs (SEM), it has been possible to show that, in a film package preferred in accordance with the invention as shown in FIG. 11:
at least one outer surface of the film lid part; and/or
at least one inner surface of the film lid part; and/or
at least one outer surface of the film pot part; and/or
at least one inner surface of the pot part; and/or
at least one film seal seam;
   have longitudinally aligned structuring, the structural elements 31 (see FIG. 13) of the structuring in the form of a longitudinal depression having at least partly a length of from 20 μm to 100 μm and/or a width of from 5 μm to 30 μm.

With regard to the disintegration time and/or dissolution time, advantageous structural elements have been found in particular to be those in which the length to width ratio amounts to substantially from 2:1 to 20:1.

Preference is further given to an inventive film package when:
at least one inner surface of the film lid part; and/or
at least one outer surface of the film pot part; and/or
at least one inner surface of the pot part; and/or
at least along one film seal seam;
   is striated over a surface area of 500 μm², having at least 20 longitudinally aligned structural elements, preferably at least 30, preferentially at least 40, further preferably at least 50, even further preferably at least 60, more preferably at least 80 and most preferably at least 100 longitudinally aligned structural elements.

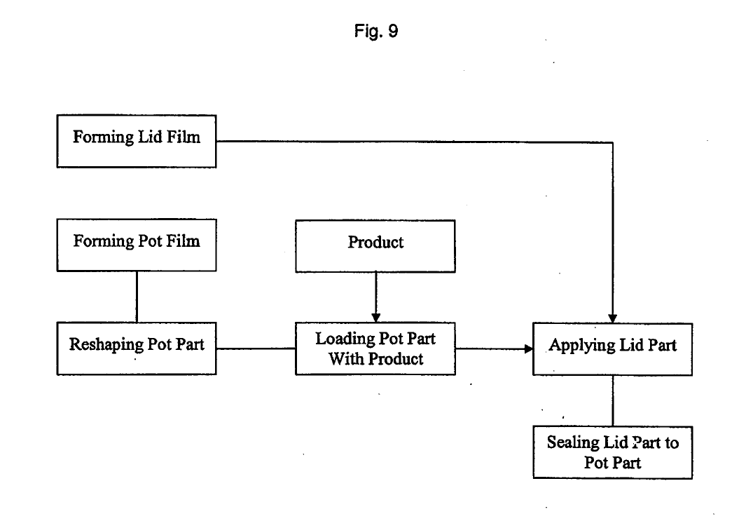

The scanning electron micrographs have also shown that at least one outer surface of the film lid part, at least one inner surface of the film lid part, at least one outer surface of the film pot part and/or at least one inner surface of the pot part may have particles formed from film material as shown at 33 in FIG. 12, such particles at least partly having a particle size in the range from 1 μm to 20 μm.

In addition, it has been possible to show by means of scanning electron micrographs that at least one film of the inventive film-packaged product portion, preferably at least one lid part film and/or pot part film, is perforated with holes as indicated at 35 in FIG. 13. Such holes may preferably have a diameter of from 1 μm to 50 μm, preferably holes having a diameter of from 5 μm to 40 μm, more preferably holes having a diameter of from 10 μm to 35 μm, and most preferably having a diameter of from 15 μm to 30 μm.

The scanning electron micrographs (SEM) were performed at 20 kV and 100-fold enlargement, unless stated otherwise. Without being bound to a particular theory, it is suspected that the structuring and/or the holes having a diameter of from 1 μm to 50 μm in at least one film of the film package are the cause of the distinct rise in the disintegration time and/or dissolution time.

The film holes 35 having a diameter of from 1 μm to 50 μm may of course be formed in the course of production of the film package during plastic reshaping.

It is preferred in accordance with the invention when at least one lid part film and/or pot part film has on average at least one hole per mm² of film, preferably on average from 2 to 100 holes per mm² of film. It is particularly preferred when the base of the pot part film has on average at least one hole per mm² of film, preferably on average from 2 to 100 holes per mm² of film, the holes preferably having a diameter of from 150 μm to 800 μm, more preferably holes having a diameter of from 200 μm to 600 μm and most preferably holes having a diameter of from 250 μm to 400 μm.

Since film holes 31 having a diameter of from 1 μm to 50 μm are known to permit at best low moisture exchange, if any, the film package or at least one film of the inventive film-packaged product portion, preferably at least one lid part film and/or pot part film, may additionally be provided with holes. For example, as indicated at 33 in FIG. 14, these additional holes may preferably have a diameter of from 100 μm to 1 mm, preferably a diameter of from 150 μm to 800 μm, more preferably a diameter of from 200 μm to 600 μm and most preferably a diameter of from 250 μm to 400 μm.

Typically, these additional holes 33 are introduced into the film by means of mechanical action, for example with a sharp object, i.e. these holes are not formed automatically in the course of plastic reshaping of a film in the production of the film package.

Especially the pot part 25 of the film package may be produced by plastic reshaping.

According to the invention, in the production of the film package 21, at least one film, preferably the base of the pot part 25, based on the length of the corresponding starting film before plastic reshaping, may be substantially plastically reshaped or stretched by from at least 20% to 400%, preferably by from at least 30% to 300%, preferentially by from at least 50% to 200%, more preferably by from 70% to 150% and more preferably from 90% to 125%.

In a preferred embodiment, the film of the lid 23 has a thickness of from 30 μm±1 μm to 38 μm±1 μm.

The pot film is preferably stretched starting from a film thickness of from 30 μm±1 μm to 38 μm±1 μm with plastic reshaping to a film thickness of from 5 μm±1 to 15 μm±1, preferably 10 μm±1. In the production of the pot part, the film may have the original film thickness in the edge region, for example outer edge region. Especially the base part of the plastically reshaped base film has a film thickness of from 5 μm±1 to 15 μm±1, preferably 10 μm±1.

The inventive film-packaged product portion may be produced from at least 1 to 5 separate films, preferably at least 2 separate film, the film or at least two films being bonded in a liquid-tight manner to form a container, preferably welded.

In a preferred embodiment of the invention, the film-packaged product portion 21 forms a container in which at least one first film 25 is shaped to accommodate the product portion by means of expansion, preferably in a pot-like manner, and at least one second film 23 which has not been substantially plastically reshaped forms the lid, the first film being bonded in a liquid-tight manner to the second film, preferably with at least one circumferential seam, especially seal seam, as indicated at 35.

In the sealing of the film package or in the bonding of films, an outer side edge can be formed, for example in the bonding of two films to one another. Measured flush or at a right angle from the connecting points or connecting line, for example seam, to the outer edge of the side edge, the side edge may have a width of from 0.5 mm to 10 mm, preferably a width of from 1 mm to 5 mm, preferably a width of from 2 to 4 mm.

It is advantageous when at least one film of the film package has a thickness of from 1 μm to 100 μm, preferably a thickness of from 10 μm to 90 μm, more preferably a thickness of from 20 μm to 80 μm and most preferably a thickness of from 30 μm to 70 μm.

Particular preference is given in accordance with the invention to a film package which has:
at least one lid film having a thickness of from 1 μm to 80 μm, preferably a thickness of from 10 μm to 60 μm, more preferably a thickness of from 20 μm to 50 μm and most preferably a thickness of from 30 μm to 40 μm; and/or
at least one pot film, especially in the region of the base part of the pot film, having a thickness of from 0.1 μm to 80 μm, preferably a thickness of from 1 μm to 60 μm, more preferably a thickness of from 5 μm to 50 μm and most preferably a thickness of from 10 μm to 20 μm.

In an inventive film-packaged product portion, a first plastically reshaped film may have substantially a thickness of from 0.1 μm to 100 μm, preferably a thickness of from 10 μm to 90 μm, more preferably a thickness of from 20 μm to 80 μm and most preferably a thickness of from 30 μm to 70 μm, and/or a second film which has not been substantially plastically reshaped may have a thickness of from 10 μm to 200 μm, more preferably a thickness of from 20 μm to 150 μm and most preferably a thickness of from 30 μm to 100 μm.

The film package or at least one film of the film package may, after full hydrolysis with potassium hydroxide (KOH) have:
from 0% by weight to 10% by weight of acetic acid, preferably from 0.6% by weight to 0.9% by weight of acetic acid, more preferably from 0.7% by weight to 0.8% by weight of acetic acid; and/or
from 0% by weight to 20% by weight of glycerol, preferably from 10% by weight to 15% by weight of glycerol, more preferably from 13% by weight to 14% by weight of glycerol; and/or
from 0% by weight to 10% by weight of sorbitol, preferably from 1% by weight to 9% by weight of sorbitol, more preferably from 3% by weight to 7% by weight of sorbitol; and/or
from 0% by weight to 10% by weight of trimethylolpropane (TMP), preferably from 0.5% by weight to 4% by weight of trimethylolpropane, more preferably from 1% by weight to 3% by weight of trimethylolpropane; and/or
from 0% by weight to 10% by weight of polyvinyl acetate, preferably from 0.1% by weight to 5% by weight of polyvinyl acetate, more preferably 0% by weight of polyvinyl acetate.

Suitable films for producing the inventive film package are based preferably on a polyvinyl alcohol whose molecular weight is in the range from 10 000 to 1 000 000 gmol⁻¹, preferably from 20 000 to 500 000 gmol⁻¹, more preferably from 30 000 to 100 000 gmol⁻¹ and in particular from 40 000 to 80 000 gmol⁻¹.

It is preferred when at least one film of the inventive film package comprises a polyvinyl alcohol whose degree of hydrolysis amounts to from 70 to 100 mol %, preferably from 80 to 90 mol %, more preferably from 81 to 89 mol % and in particular from 82 to 88 mol %.

A suitable film for producing the inventive film package may be additionally added polymers selected from the group comprising acrylic acid-containing polymers, polyacrylamides, oxazoline polymers, polystyrenesulfonates, polyurethanes, polyesters, polyethers and/or mixtures of the above polymers.

It is also preferred that the film package or at least one film of the film-packaged product portion has:
a breaking strength in the range from 20 N/mm² to 50 N/mm², preferably in the range from 25 N/mm² to 45 N/mm², further preferably in the range from 30 N/mm² to 40 N/mm², even further preferably in the range from 32 N/mm² to 38 N/mm² and most preferably in the range from 34 N/mm² to 36 N/mm²; and/or
a modulus of elasticity in the range from 4 N/mm² to 20 N/mm², preferably in the range from 5 N/mm² to 18 N/mm², further preferably in the range from 6 N/mm² to 16 N/mm², even further preferably in the range from 8 N/mm² to 14 N/mm² and most preferably in the range from 10 N/mm² to 12 N/mm²; and/or
an elongation at break in the range from 150% to 1000%, preferably in the range from 180% to 900%, further preferably in the range from 200% to 800%, even further preferably in the range from 250% to 750% and most preferably in the range from 300% to 450%; and/or
a tear propagation resistance of from 20 g/mm² to 60 g/mm², preferably in the range from 25 g/mm² to 55 g/mm², further preferably in the range from 30 g/mm² to 50 g/mm², even further preferably in the range from 32 g/mm² to 48 g/mm² and most preferably in the range from 35 g/mm² to 45 g/mm²; and/or
an impact resistance of from 100 g to 2000 g/mm², preferably in the range from 150 g to 1500 g, further preferably in the range from 200 g to 1000 g, even further preferably in the range from 300 g to 800 g, and most preferably in the range from 400 g to 750 g.

The film-packaged product portion may be filled with the product to an extent of at least 50% by volume, preferably to an extent of at least 60% by volume, preferentially to an extent of at least 70% by volume, further preferably to an extent of at least 80% by volume, most preferably to an extent of from 90% by volume to no more than 100% by volume.

The inventive film-packaged product portion may have a mean filling amount of from 0.1 g to 100 kg, preferably of from 1 g to 10 kg, preferentially of from 10 g to 1 kg, further preferably of from 30 g to 500 g, more preferably of from 70 g to 200 g.

The product or the product portion may be in solid, liquid, foam and/or gel form at room temperature, the product preferably being solid.

In general, the product in the film-packaged product portion may be present in the form of at least one shaped body selected from the group of tablet(s), granule(s), capsule(s) and/or powder.

It is also conceivable that the product or product portion form a plurality of phases, preferably from at least 2 to 5 phases. Such products or product portions which form separate phases are known. Suitable systems here are both liquid/liquid and solid/liquid, or solid/solid systems. Also suitable are products or product portions which, for example as a result of shaking, form a temporary phase and do not demix again to form separate phases until after prolonged standing.

However, it is also possible to provide an inventive film-packaged product portion which comprises at least 2 compartments, preferably from 3 to 5 compartments, for the accommodation of product. For example, it is thus possible to introduce products or product portions into the particular compartments in different proportions by weight and/or different composition. This is particularly advantageous when the risk of mutual deactivation exists for individual components of the product and/or when the components are to be released at different times. For example, components with a different state of matter can be divided between different compartments and/or the film thickness of the particular compartment can be configured in different thickness, as a result of which a different release rate is likewise achievable.

Especially with regard to storage, it may be advantageous when the inventive film package has a plurality of compartments. As a result, it becomes possible, for example, to separate a solid, in particular powder, and a liquid or gel from one another without the solid mixing or dissolving prematurely in the liquid and/or the gel before application at the point of use.

However, the simplest case is a film-packaged product portion with one compartment. A film-packaged product portion with one compartment can be formed, for example, from a shell composed of at least one film, preferably two films, which contains or encloses the product portion. When two films are used, for example, one forms the lid part and one the pot part.

The film-packaged product portion may, for example, have products having a mean particle size of from 0.01 μm to 4 mm, preferably of from 0.02 μm to 3.5 mm, preferentially of from 0.03 μm to 3.0 mm and further preferably of from 0.04 μm to 2.5 mm.

The product present in the inventive film package preferably has a bulk density of from 200 g/l to 1000 g/l, preferably of from 300 g/l to 900 g/l, preferentially of from 400 g/l to 800 g/l.

The water absorption of an inventive film-packaged product portion may, for example, in the course of storage of 4 weeks at room temperature of between 20 to 25° C. and a relative atmospheric humidity of from 20 to 40%, be in the range from 0% by weight to no more than 1% by weight, preferably no more than 0.5% by weight, preferentially no more than 0.1% by weight and more preferably 0% by weight.

In addition, the water absorption of an inventive film-packaged product portion may, for example in the course of storage of 4 weeks at a room temperature of 23° C. and a relative atmospheric humidity of 80%, be in the range of no more than 0.5% by weight, preferably no more than 4% by weight, preferentially no more than 3% by weight and more preferably no more than 2.5% by weight.

The above weight data are based on the total weight of the inventive film-packaged product portion.

The inventive film-packaged product portion may have, as a means for performing the storage tests, for example, WIPP—Progres, obtainable in Spain from Henkel.

The product or the product portion film-packaged in accordance with the invention may have a plurality of components selected from the group comprising, as washing-, care- and/or cleaning-active substances, anionic surfactants, cationic surfactants, amphoteric surfactants, nonionic surfactants, builder substances, bleaches, bleach activators, bleach stabilizers, bleach catalysts, enzymes, polymers, cobuilders, alkalizers, acidifiers, antiredeposition agents, silver protectants, colorants, optical brighteners, UV-protective substances, fabric softeners, perfume, foam inhibitors and/or rinse aids, and also any further constituents added.

In a preferred embodiment, the inventive film-packaged product portion comprises:
from 5% by weight to 30% by weight, preferably from 7% by weight to 28% by weight, preferentially from 8% by weight to 25% by weight of surfactant; and/or
from 0% by weight to no more than 35% by weight, preferably from 8% by weight to 30% by weight, preferentially from 10% by weight to 25% by weight of bicarbonate; and/or
from 0% by weight to no more than 35% by weight, preferably from 8% by weight to 30% by weight, preferentially from 10% by weight to 25% by weight of carbonate; and/or
from 0% by weight to no more than 10% by weight, preferably from 0.5% by weight to 8% by weight, preferentially from 1% by weight to 5% by weight of bleach activator; and/or
from 0% by weight to no more than 35% by weight, preferably from 3% by weight to 30% by weight, preferentially from 5% by weight to 20% by weight of phosphate, the product most preferably being phosphate-free; and/or
from 0% by weight to no more than 20% by weight, preferably from 1% by weight to 15% by weight, preferentially from 2% by weight to 5% by weight of zeolite; and/or
from 0% by weight to no more than 10% by weight, preferably from 0.5% by weight to 8% by weight, preferentially from 1% by weight to 6% by weight of silicate; and/or
from 0% by weight to no more than 25% by weight, preferably from 5% by weight to 18% by weight, preferentially from 12% by weight to 16% by weight of bleach.

In the context of this invention, the data in % by weight, unless stated otherwise, are based upon the total weight of the product or the product portion.

It is particularly preferred when the product or product portion comprises no phosphate and/or no zeolite.

However, it is desirable when the product or the product portion comprises zeolite such that this fraction, based on the total weight of the product or of the product portion, is less than 5% by weight, preferably not more than 4% by weight, not more than 3% by weight or not more than 2% by weight.

As a soluble builder, the product or the product portion may comprise from 10% by weight to 30% by weight, preferably from 15% by weight to 25% by weight and more preferably from 18% by weight to 20% by weight, based on the total weight of the product or of the product portion, particular preference being given to sodium carbonate as the soluble builder.

In contrast, it is advantageous when the fraction of bicarbonates in the product or in the product portion is at a minimum. For example, the bicarbonate content in the product or in the product portion may amount to between 0% by weight and no more than 15% by weight, preferably no less than 1% by weight and no more than 13% by weight, further preferably no less than 2% by weight and no more than 11% by weight, even further preferably no less than 3% by weight and no more than 9% by weight and more preferably no less than 5% by weight and no more than 7% by weight.

Film-packaged products producible in accordance with the invention, especially laundry detergents, care compositions and cleaning compositions, preferably have surfactants, inorganic and optionally organic builder substances and optionally further customary ingredients, the inorganic constituents present preferably being water-soluble.

The film-packaged product and/or film-packaged product portion produced in accordance with the invention has/have at least one component, preferably a plurality of components, selected from the group comprising, as washing-, care- and/or cleaning-active substances, anionic surfactants, cationic surfactants, amphoteric surfactants, nonionic surfactants, builder substances, bleaches, bleach activators, bleach stabilizers, bleach catalysts, enzymes, polymers, cobuilders, alkalizers, acidifiers, antiredeposition agents, silver protectants, colorants, optical brighteners, UV-protective substances, fabric softeners and/or rinse aids, and also any further constituents added.

The anionic surfactants used are, for example, those of the sulfonate and sulfate type. Useful surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination or sulfoxidation with subsequent hydrolysis or neutralization. The esters of □-sulfo fatty acids (ester sulfonates), for example the □-sulfonated methyl esters of hydrogenated coconut, palm kernel or tallow fatty acids, are also likewise suitable.

Further suitable anionic surfactants are sulfated fatty acid glycerol esters. Fatty acid glycerol esters refer to the mono-, di- and triesters, and mixtures thereof, as are obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having from 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric monoesters of C₁₂-C₁₈ fatty alcohols, for example of coconut fatty alcohol, tallow fatty alcohol, lauryl, myristyl, cetyl or stearyl alcohol, or of C₁₀-C₂₀ oxo alcohols and those monoesters of secondary alcohols of these chain lengths. Also preferred are alk(en)yl sulfates of the chain length mentioned which contain a synthetic straight-chain alkyl radical prepared on a petrochemical basis and which have analogous degradation behavior to the equivalent compounds based on fatty chemical raw materials. From the washing point of view, preference is given to the C₁₂-C₁₆-alkyl sulfates and C₁₂-C₁₅-alkyl sulfates, and C₁₄-C₁₅-alkyl sulfates. 2,3-Alkyl sulfates, which can be obtained as commercial products from the Shell Oil Company under the name DAN_, are also suitable anionic surfactants.

Also suitable are the sulfuric monoesters of the straight-chain or branched C₇₋₂₁-alcohols ethoxylated with 1 to 6 mol of ethylene oxide, such as 2-methyl-branched C₉₋₁₁-alcohols with on average 3.5 mol of ethylene oxide (EO) or C₁₂₋₁₈-fatty alcohols with from 1 to 4 EO. Owing to their high tendency to foam, they are used in cleaning products only in relatively small amounts, for example in amounts of from 1 to 5% by weight.

Further suitable anionic surfactants are also the salts of alkylsulfosuccinic acid, which are also referred to as sulfosuccinates or as sulfosuccinic esters and are the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. Especially preferred sulfosuccinates contain a fatty alcohol radical which is derived from ethoxylated fatty alcohols which, considered alone, constitute nonionic surfactants (see below for description). In this context, particular preference is in turn given to sulfosuccinates whose fatty alcohol radicals derive from ethoxylated fatty alcohols with a narrowed homolog distribution. It is also equally possible to use alk(en)ylsuccinic acid having preferably from 8 to 18 carbon atoms in the alk(en)yl chain or salts thereof.

The content in the product portion of the anionic surfactants mentioned is preferably from 2 to 30% by weight and in particular from 5 to 25% by weight, concentrations above 10% by weight and even above 15% by weight finding particular preference.

In addition to the anionic surfactants mentioned, soaps may also be present. Suitable soaps are in particular saturated fatty acid soaps such as the salts of lauric acid, myristic acid, palmitic acid, stearic acid, hydrogenated erucic acid and behenic acid, and also in particular soap mixtures derived from natural fatty acids, for example coconut, palm kernel or tallow fatty acids. The content in the product portion of soaps is preferably not more than 3% by weight and in particular from 0.5 to 2.5% by weight.

The anionic surfactants and soaps may be present in the form of their sodium, potassium or ammonium salts, and also as soluble salts of organic bases such as mono-, di- or triethanolamine. They are preferably present in the form of their sodium or potassium salts, in particular in the form of the sodium salts. Anionic surfactants and soaps may also be prepared in situ by introducing the anionic surfactant acids and optionally fatty acids, which are then neutralized by the alkali carriers in the composition to be spray-dried, into the composition to be spray-dried.

Nonionic surfactants are typically present in direct spray-dried products, if at all, only in minor amounts. For example, their content may be up to 2 or 3% by weight. For a more precise description of the nonionic surfactants, reference is made to the description of the after-treated products below. In this connection, it is also significant that products produced by granulation or compounding may of course also be after-treated and are usable in accordance with the invention.

The cleaning, care and washing product portion(s) usable in accordance with the invention may optionally also comprise cationic surfactants. Suitable cationic surfactants are, for example, surface-active quaternary compounds, especially having an ammonium, sulfonium, phosphonium, iodonium or arsonium group, which are described as antimicrobial substances, for example, by K. H. Wallhäusser in “Praxis der Sterilisation, Desinfektion—Konservierung: Keimidentifizierung—Betriebshygiene” [Practice of Sterilization, Disinfection—Preservation: Germ Identification—Workplace Hygiene] (5^{th} ed.—Stuttgart; New York: Thieme, 1995). The use of quaternary surface-active compounds having antimicrobial action may equip the product with antimicrobial action or improve any antimicrobial action already present owing to other ingredients.

Particularly preferred cationic surfactants are the quaternary ammonium compounds, some of which are antimicrobially active, (QACs; INCI Quaternary Ammonium Compounds) of the general formula (R^{I})(R^{II})(R^{III})(R^{IV})N⁺X⁻ in which R^{I} to R^{IV} are identical or different C₁₋₂₂-alkyl radicals, C₇₋₂₈-aralkyl radicals or heterocyclic radicals, in which two, or, in the case of an aromatic single bond as in pyridine, even three radicals, together with the nitrogen atom form the heterocycle, for example a pyridinium or imidazolinium compound, and X⁻ are halide ions, sulfate ions, hydroxide ions or similar anions. For an optimal antimicrobial action, at least one of the radicals preferably has a chain length of from 8 to 18, in particular from 12 to 16 carbon atoms.

QACs can be prepared by reacting tertiary amines with alkylating agents, for example methyl chloride, benzyl chloride, dimethyl sulfate, dodecyl bromide, but also ethylene oxide. The alkylation of tertiary amines having a long alkyl radical and two methyl groups succeeds particularly readily, and the quaternization of tertiary amines having two long radicals and a methyl group may also be carried out with the aid of methyl chloride under mild conditions. Amines which have three long alkyl radicals or hydroxyl-substituted alkyl radicals have low reactivity and are preferably quaternized with dimethyl sulfate.

Suitable QACs are, for example, benzalkonium chloride (N-alkyl-N,N-dimethylbenzylammonium chloride, CAS No. 8001-54-5), benzalkone B (m,p-dichlorobenzyldimethyl-C₁₂-alkylammonium chloride, CAS No. 58390-78-6), benzoxonium chloride (benzyldodecylbis(2-hydroxyethyl)ammonium chloride), cetrimonium bromide (N-hexadecyl-N,N-trimethylammonium bromide, CAS No. 57-09-0), benzetonium chloride (N,N-dimethyl-N-[2-[2-[p-(1,1,3,3-tetramethylbutyl)phenoxy]ethoxy]ethyl]benzylammonium chloride, CAS No. 121-54-0), dialkyldimethylammonium chlorides such as di-n-decyldimethylammonium chloride (CAS No. 7173-51-5-5), didecyldimethylammonium bromide (CAS No. 2390-68-3), dioctyldimethylammonium chloride, 1-cetylpyridinium chloride (CAS No. 123-03-5) and thiazoline iodide (CAS No. 15764-48-1) and also mixtures thereof. Preferred QACs are the benzalkonium chlorides having C₈-C₁₈-alkyl radicals, in particular C₁₂-C₁₄-alkylbenzyldimethylammonium chloride. A particularly preferred QAC is cocopentaethoxymethylammonium methosulfate (INCI PEG-5 Cocomonium Methosulfate; Rewoquat® CPEM).

To avoid possible incompatibilities of the antimicrobial cationic surfactants with the anionic surfactants present in accordance with the invention, very substantially anionic surfactant-compatible and/or very little cationic surfactant is used, or, in a particular embodiment of the invention, antimicrobially active cationic surfactants are dispensed with entirely.

The antimicrobially active substances used may be parabens, benzoic acid and/or benzoate, lactic acid, salicylic acid and/or lactates. Particular preference is given to benzoic acid and/or lactic acid.

The inventive cleaning, care and washing product portion(s) may comprise one or more cationic surfactants in amounts, based on the overall composition, of from 0 to 5% by weight, from greater than 0 to 5% by weight, preferably from 0.01 to 3% by weight, in particular from 0.1 to 1% by weight.

The inventive cleaning, care and washing product portion(s) may equally also comprise amphoteric surfactants. Suitable amphoteric surfactants are, for example, betaines of the formula (R¹)(R²)(R³)N⁺CH₂CO⁻, in which R¹ is an alkyl radical which is optionally interrupted by heteroatoms or heteroatomic groups and has from 8 to 25, preferably from 10 to 21 carbon atoms, and R² and R³ are identical or different alkyl radicals having from 1 to 3 carbon atoms, in particular C₁₀-C₂₂-alkyldimethylcarboxymethylbetaine and C₁₁-C₁₇alkylamido-propyldimethylcarboxymethylbetaine. In addition, it is conceivable to use alkylamidoalkylamines, alkyl-substituted amino acids, acylated amino acids or biosurfactants as amphosurfactants in the inventive film-packaged cleaning, care and washing product portion(s).

The inventive film-packaged cleaning, care and washing product portion(s) may comprise one or more amphoteric surfactants in amounts, based on the overall composition, of from 0 to 5% by weight, from greater than 0 to 5% by weight, preferably from 0.01 to 3% by weight, in particular from 0.1 to 1% by weight.

Further ingredients of the film-packaged product may be inorganic and optionally organic builder substances. The inorganic builder substances include water-insoluble or non-water-soluble ingredients such as aluminosilicates and in particular zeolites. The finely crystalline zeolite used, which comprises synthetic and bound water, is preferably zeolite A and/or P. The zeolite P used is, for example, Zeolite MAP^{(R)} (commercial product from Crosfield). However, also suitable are zeolite X and mixtures of A, X and/or P. Also of particular interest is a cocrystallized sodium/potassium aluminosilicate composed of zeolite A and zeolite X, which is commercially available as VEGOBOND AX (commercial product from Condea Augusta S.p.A.). This product is described in detail below. The zeolite may be used in the form of spray-dried powder or else in the form of undried, stabilized suspension still moist from its preparation. In the case that the zeolite is used in the form of a suspension, it may contain small additions of nonionic surfactants as stabilizers, for example from 1 to 3% by weight, based on zeolite, of ethoxylated C₁₂-C₁₈-fatty alcohols having from 2 to 5 ethylene oxide groups, C₁₂-C₁₄-fatty alcohols having from 4 to 5 ethylene oxide groups or ethoxylated isotridecanols. Suitable zeolites have an average particle size of less than 10 μm (volume distribution; measurement method: Coulter counter) and contain preferably 18 to 22% by weight, in particular 20 to 22% by weight, of bound water.

As further particularly suitable zeolites, mention should be made of zeolites of the faujasite type. Together with the zeolites X and Y, the mineral faujasite belongs to the faujasite types within the zeolite structural group 4, which is characterized by the double-hexagon subunit D6R (cf. Donald W. Breck: AZeolite Molecular Sieves@, John Wiley & Sons, New York, London, Sydney, Toronto, 1974, page 92). In addition to the abovementioned faujasite types, the zeolite structural group 4 also includes the minerals chabazite and gmelinite and also the synthetic zeolites R (chabazite type), S (gmelinite type), L, and ZK-5. The two last-mentioned synthetic zeolites have no mineral analogs.

Zeolites of the faujasite type are composed of β cages linked tetrahedrally by way of D6R subunits, the β cages being arranged in a manner similar to the carbon atoms in diamond. The three-dimensional network of the faujasite-type zeolites suitable for use in the process of the invention has pores of 2.2 and 7.4 Å; the unit cell additionally includes 8 cavities having a diameter of approx. 13 Å and can be described by the formula Na₈₆[(AlO₂)₈₆(SiO₂)₁₀₆] 264H₂O. The network of zeolite X includes a cavity volume of approximately 50%, based on the dehydrated crystal, which constitutes the largest empty space of all known zeolites (zeolite Y: approx. 48% cavity volume, faujasite: approx. 47% cavity volume). (All data from: Donald W. Breck: AZeolite Molecular Sieves@, John Wiley & Sons, New York, London, Sydney, Toronto, 1974, pages 145, 176, 177.)

In the context of the present invention, the term Afaujasite-type zeolite@ denotes all three zeolites which form the faujasite subgroup of the zeolite structural group 4. In addition to zeolite X, also suitable in accordance with the invention are thus zeolite Y and faujasite, and mixtures of these compounds, preference being given to pure zeolite X.

Mixtures or cocrystals of zeolites of the faujasite type with other zeolites, which need not necessarily belong to the zeolite structural group 4, are also suitable in accordance with the invention, preferably at least 50% by weight of the zeolites being faujasite-type zeolites.

The suitable aluminosilicates are commercially available, and the methods of their preparation are described in standard monographs.

Examples of commercially available zeolites of the X type may be described by the following formulae:
Na₈₆[(AlO₂)₈₆(SiO₂)₁₀₆].xH₂O,
K₈₆[(AlO₂)₈₆(SiO₂)₁₀₆].xH₂O,
Ca₄₀Na₆[(AlO₂)₈₆(SiO₂)₁₀₆].xH₂O,
Sr₂₁Ba₂₂[(AlO₂)₈₆(SiO₂)₁₀₆].xH₂O,
in which x may assume values of from greater than 0 to 276. These zeolites have pore sizes of from 8.0 to 8.4 Å.

Also suitable is, for example, the zeolite A-LSX described in the European patent application EP-A-8 16 291, which corresponds to a cocrystal of zeolite X and zeolite A and, in its anhydrous form, has the formula (M_{2/n}O+M′_{2/n}O).Al₂O₃.zSiO₂ where M and M′ may be alkali metals or alkaline earth metals and z is from 2.1 to 2.6. This product is commercially available under the brand name VEGOBOND AX from CONDEA Augusta S.p.A.

Zeolites of the Y type are also commercially available and may be described, for example, by the formulae
Na₅₆[(AlO₂)₅₆(SiO₂)₁₃₆].xH₂O,
K₅₆[(AlO₂)₅₆(SiO₂)₁₃₆].xH₂O,
in which x represents numbers from greater than 0 to 276. These zeolites have pore sizes of 8.0 Å.

The particle sizes of the suitable faujasite-type zeolites are within the range from 0.1 up to 100 μm, preferably from 0.5 to 50 μm, and in particular from 1 to 30 μm, measured in each case with standard particle size determination methods.

In another fundamental embodiment of the invention the inorganic constituents should, however, be water-soluble. In these embodiments, builder substances other than the zeolites mentioned are therefore used.

In cases in which a phosphate content can be tolerated, it is also possible to additionally use phosphates, especially pentasodium triphosphate, optionally also pyrophosphates and orthophosphates, which act primarily as precipitants for lime salts. Phosphates are used predominantly in machine dishwasher detergents, but sometimes also in laundry detergents.

Alkali metal phosphates is the collective term for the alkali metal (especially sodium and potassium) salts of the various phosphoric acids, for which a distinction may be drawn between metaphosphoric acids (HPO₃)ₙ and orthophosphoric acid H₃PO₄, in addition to higher molecular weight representatives. The phosphates combine a number of advantages: they act as alkali carriers, prevent limescale deposits on machine components and lime encrustations in fabrics, and additionally contribute to the cleaning performance.

Sodium dihydrogenphosphate, NaH₂PO₄, exists as the dihydrate (density 1.91 gcm⁻³, melting point 60-) and as the monohydrate (density 2.04 gcm⁻³). Both salts are white powders which are very readily soluble in water and which lose the water of crystallization upon heating and are converted at 200-C to the weakly acidic diphosphate (disodium hydrogendiphosphate, Na₂H₂P₂O₇), and at higher temperature to sodium trimetaphosphate (Na₃P₃O₉) and Maddrell salt (see below). NaH₂PO₄ reacts acidically; it is formed when phosphoric acid is adjusted to a pH of 4.5 using sodium hydroxide solution and the slurry is sprayed. Potassium dihydrogenphosphate (primary or monobasic potassium phosphate, potassium biphosphate, KDP), KH₂PO₄, is a white salt of density of 2.33 gcm⁻³, has a KH₂PO₄, is a white salt of density of 2.33 gcm⁻³, has a melting point of 253- [decomposition with formation of potassium polyphosphate (KPO₃)ₓ] and is readily soluble in water.

Disodium hydrogenphosphate (secondary sodium phosphate), Na₂HPO₄, is a colorless crystalline salt which is very readily soluble in water. It exists in anhydrous form and with 2 mol of water (density 2.066 gcm⁻³, loss of water at 95-), 7 mol of water (density 1.68 gcm⁻³, melting point 48- with loss of 5H₂O) and 12 mol of water (density 1.52 gcm⁻³, melting point 35- with loss of 5H₂O), becomes anhydrous at 100- and, when heated more strongly, is converted to the diphosphate Na₄P₂O₇. Disodium hydrogenphosphate is prepared by neutralizing phosphoric acid with sodium carbonate solution using phenolphthalein as an indicator. Dipotassium hydrogenphosphate (secondary or dibasic potassium phosphate), K₂HPO₄, is an amorphous white salt which is readily soluble in water.

Trisodium phosphate, tertiary sodium phosphate, Na₃PO₄, are colorless crystals which have a density of 1.62 gcm⁻³ and a melting point of 73-76-C (decomposition) in the form of the dodecahydrate, have a melting point of 100-C in the form of the decahydrate (corresponding to 19-20% P₂O₅), and have a density of 2.536 gcm⁻³ in anhydrous form (corresponding to 39-40% P₂O₅). Trisodium phosphate is readily soluble in water, with an alkaline reaction, and is prepared by evaporatively concentrating a solution of precisely 1 mol of disodium phosphate and 1 mol of NaOH. Tripotassium phosphate (tertiary or tribasic potassium phosphate), K₃PO₄, is a white, deliquescent, granular powder of density 2.56 gcm⁻³, has a melting point of 1340- and is readily soluble in water with an alkaline reaction. It is produced, for example, when Thomas slag is heated with charcoal and potassium sulfate. Despite the relatively high cost, the more readily soluble and therefore highly active potassium phosphates are frequently preferred in the cleaning products industry over corresponding sodium compounds.

Tetrasodium diphosphate (sodium pyrophosphate), Na₄P₂O₇, exists in anhydrous form (density 2.534 gcm⁻³, melting point 988-, 880- also reported) and in the form of the decahydrate (density 1.815-1.836 gcm⁻³, melting point 94- with loss of water). Both substances are colorless crystals which dissolve in water with an alkaline reaction. Na₄P₂O₇ is formed when disodium phosphate is heated to >200- or by reacting phosphoric acid with sodium carbonate in the stoichiometric ratio and dewatering the solution by spraying. The decahydrate complexes heavy metal salts and hardness formers and therefore reduces the hardness of water. Potassium diphosphate (potassium pyrophosphate), K₄P₂O₇, exists in the form of the trihydrate and is a colorless, hygroscopic powder of density 2.33 gcm³, which is soluble in water, the pH of the 1% solution at 25- being 10.4.

Condensation of NaH₂PO₄ or of KH₂PO₄ gives rise to higher molecular weight sodium phosphates and potassium phosphates, for which a distinction can be drawn between cyclic representatives, the sodium metaphosphates and potassium metaphosphates, and catenated types, the sodium polyphosphates and potassium polyphosphates. For the latter in particular a multitude of names are in use: fused or calcined phosphates, Graham salt, Kurrol salt and Maddrell salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6H₂O and has the general formula NaO—[P(O)(ONa)—O]ₙ—Na where n=3. About 17 g of the salt which is free of water of crystallization dissolve in 100 g of water at room temperature, at 60- approx. 20 g, at 100- around 32 g; after the solution has been heated at 100- for two hours, hydrolysis forms about 8% orthophosphate and 15% diphosphate. In the preparation of pentasodium triphosphate, phosphoric acid is reacted with sodium carbonate solution or sodium hydroxide solution in the stoichiometric ratio and the solution is dewatered by spraying. In a similar way to Graham salt and sodium diphosphate, pentasodium triphosphate dissolves many insoluble metal compounds (including lime soaps etc.). Pentapotassium triphosphate, K₅P₃O₁₀ (potassium tripolyphosphate), is available commercially, for example, in the form of a 50% by weight solution (>23% P₂O₅, 25% K₂O). The potassium polyphosphates find wide use in the laundry detergents and cleaning products industry. There also exist sodium potassium tripolyphosphates which can likewise be used in the context of the present invention. They are formed, for example, when sodium trimetaphosphate is hydrolyzed with KOH:
(NaPO₃)₃+2KOH→Na₃K₂P₃O₁₀+H₂O

They can be used in accordance with the invention in precisely the same way as sodium tripolyphosphate, potassium tripolyphosphate or mixtures of the two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used in accordance with the invention.

However, in a preferred embodiment of the invention, the inorganic builder substances used are especially carbonates and silicates.

Mention should be made here of crystalline, sheet-type sodium silicates of the general formula NaMSiₓO₂ₓ₊.yH2O where M is sodium or hydrogen, x is from 1.6 to 4, preferably from 1.9 to 4.0, and y is from 0 to 20, and preferred values for x are 2, 3 or 4. However, since such crystalline silicates at least partly lose their crystalline structure in a spray-drying process, crystalline silicates are preferably added subsequently to the direct or after-treated spray-drying product. Such crystalline sheet silicates are described, for example, in the European patent application EP-A-0 164 514. Preferred crystalline sheet silicates of the formula specified are those in which M is sodium and x assumes the values of 2 or 3. Especially preferred are both □- and □-sodium disilicates Na₂Si₂O₅□yH₂O. Such compounds are commercially available, for example, under the name SKS^{□} (Clariant). For instance, SKS-6^{□} is predominantly an □-sodium disilicate with the formula Na₂Si₂O₅□yH₂O, SKS-7^{□} predominantly the □-sodium disilicate. Reaction with acids (e.g. citric acid or carbonic acid) forms, from the □-sodium disilicate, kanemit NaHSi₂O₅□yH₂O, commercially available under the names SKS-9^{□} or SKS-10^{□} (Clariant). It may also be advantageous to use chemical modifications of this sheet silicate. For example, the alkalinity of the sheet silicates may be influenced suitably. In comparison to □-sodium disilicate, phosphate- or carbonate-doped sheet silicates have changed crystal morphologies, dissolve more rapidly and, in comparison to □-sodium disilicate, exhibit an increased calcium binding capacity. For instance, sheet silicates of the general empirical formula x Na₂O $ y SiO₂ $ z P₂O₅ in which the x to y ratio is from 0.35 to 0.6, the x to z ratio is from 1.75 to 1200 and the y to z ratio is from 4 to 2800 are described in the patent application DE-A-196 01 063. The solubility of the sheet silicates can also be increased by using particularly finely divided sheet silicates. Compounds of the crystalline sheet silicates with other ingredients may also be used. Mention should be made in particular of compounds with cellulose derivatives which have advantages in the disintegrating action, and also compounds with polycarboxylates, for example citric acid, or polymeric polycarboxylates, for example copolymers of acrylic acid.

The preferred builder substances also include amorphous sodium silicates having an Na₂O:SiO₂ modulus of from 1:2 to 1:3.3, preferably from 1:2 to 1:2.8 and in particular from 1:2 to 1:2.6, which have secondary washing properties. In the context of this invention, the term “amorphous” is also understood to mean “X-ray amorphous”. This means that the silicates, in X-ray diffraction experiments, do not afford any sharp X-ray reflections typical of crystalline substances, but rather at best one or more maxima of the scattered X-radiation, which have a width of several degree units of the diffraction angle. However, it may quite possibly lead even to particularly good builder properties if the silicate particles in electron diffraction experiments afford vague or even sharp diffraction maxima. This should be interpreted such that the products have microcrystalline regions of size from 10 to several hundred nm, preference being given to values up to max. 50 nm and in particular up to max. 20 nm. Such so-called X-ray-amorphous silicates, which likewise have retarded dissolution compared to conventional waterglasses, are described, for example, in the German patent application DE-A-44 00 024. Especially preferred are compacted amorphous silicates, compounded amorphous silicates and overdried X-ray-amorphous silicates. The content of the (X-ray-)amorphous silicates in the zeolite-free product portions is preferably from 1 to 10% by weight.

However, particularly preferred inorganic water-soluble builders are alkali metal carbonates and alkali metal bicarbonates, the preferred embodiments including sodium carbonate and potassium carbonate and especially sodium carbonate. The content of the alkali metal carbonates in the especially zeolite-free product portions may vary within a very wide range and is preferably from 5 to 40% by weight, in particular from 8 to 30% by weight, the content of alkali metal carbonates typically being higher than of (X-ray-)amorphous silicates.

Organic builder substances which can be used are, for example, the polycarboxylic acids usable in the form of their alkali metal salts and in particular sodium salts, such as citric acid, adipic acid, succinic acid, glutaric acid, tartaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

Also suitable as organic builders are polymeric polycarboxylates; these are, for example, the alkali metal salts of polyacrylic acid or of polymethacrylic acid, for example those having a relative molecular mass of from 500 to 70 000 g/mol. In the context of this document, the molar masses specified for polymeric polycarboxylates are weight-average molar masses M_{W} of the particular acid form, which has always been determined by means of gel-permeation chromatography (GPC) using a UV detector. The measurement was against an external polyacrylic acid standard which, owing to its structural similarity to the polymers under investigation, provides realistic molecular weight values. These figures deviate considerably from the molecular weight data when polystyrenesulfonic acids are used as the standard. The molar masses measured against polystyrenesulfonic acids are generally distinctly higher than the molar masses specified in this document.

Suitable polymers are in particular polyacrylates which preferably have a molecular mass of from 2000 to 20 000 g/mol. Owing to their superior solubility, preference within this group may be given in turn to the short-chain polyacrylates which have molar masses of from 2000 to 10 000 g/mol and more preferably from 3000 to 5000 g/mol.

Also suitable are copolymeric polycarboxylates, especially those of acrylic acid with methacrylic acid and of acrylic acid or methacrylic acid with maleic acid. Copolymers which have been found to be particularly suitable are those of acrylic acid with maleic acid which contain from 50 to 90% by weight of acrylic acid and from 50 to 10% by weight of maleic acid. Their relative molecular mass, based on free acids, is generally from 2000 to 70 000 g/mol, preferably from 20 000 to 50 000 g/mol and in particular from 30 000 to 40 000 g/mol.

The content in the product portion of organic builder substances may likewise vary within a wide range. Preference is given to contents of from 2 to 20% by weight, and contents of not more than 10% by weight in particular find favor especially for reasons of cost.

From the remaining groups of customary washing product constituents, additionally used in the inventive film-packaged products are components from the classes of the graying inhibitors (soil carriers), the neutral salts and the textile-softening assistants (see cationic surfactants above).

Graying inhibitors have the task of keeping the soil detached from the fiber suspended in the liquor, thus preventing the soil from reattaching. Suitable for this purpose are water-soluble colloids, usually of organic nature, for example the water-soluble salts of polymeric carboxylic acids, size, gelatin, salts of ether carboxylic acids or ether sulfonic acids of starch or of cellulose, or salts of acidic sulfuric esters of cellulose or of starch. Also suitable for this purpose are water-soluble polyamides containing acid groups. It is additionally possible to use soluble starch preparations and starch products other than those mentioned above, for example degraded starch, aldehyde starches, etc. It is also possible to use polyvinylpyrrolidone. However, preference is given to cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose and mixtures thereof, and also polyvinylpyrrolidone, for example in amounts of from 0.1 to 5% by weight based on the product.

As a typical example of a suitable representative of the neutral salts, mention should be made of the sodium sulfate already mentioned. It may be used in amounts of, for example, from 2 to 45% by weight.

Suitable softeners are, for example, swellable sheet silicates of the type corresponding to montmorillonites, for example bentonite.

The content of water in film-packaged products is preferably from 0 to less than 10% by weight and in particular from 0.5 to 8% by weight, values of not more than 5% by weight finding particular preference. Not included here was the water adhering to any aluminosilicates present, such as zeolite.

The inventive film-packaged product portion(s) may have outstanding flow behavior.

The particles of the film-packaged product produced in accordance with the invention may be after-treated, for example by rounding the particles of the film-packaged product. The rounding can be effected in a customary rounder. The rounding time is preferably not longer than 4 minutes, in particular not longer than 3.5 minutes. Rounding times of not more than 1.5 minutes or below are especially preferred. The rounding achieves further uniformization of the particle spectrum, since any agglomerates formed are comminuted.

Before the rounding, the product may have been after-treated with nonionic surfactants, perfume and/or foam inhibitors or formulation forms which comprise these ingredients, preferably with amounts of up to 20% by weight of active substance, in particular with amounts of from 2 to 18% by weight of active substance, basing each case on the after-treated product, in a manner known per se, preferably in a mixer or optionally a fluidized bed.

In particular, the product may have been after-treated with solids, preferably in amounts of up to 15% by weight, in particular in amounts of from 2 to 15% by weight, basing each case on the total weight of the after-treated product.

The solids used can preferably be bicarbonate, carbonate, zeolite, silica, citrate, urea or mixtures thereof, in particular in amounts of from 2 to 15% by weight based on the weight of the after-treated product. The after-treatment can be carried out advantageously in a mixer and/or by means of a rounder.

In the after-treatment step, it is therefore possible to powder the product with a solid, for example silicas, zeolites, carbonates, bicarbonates and/or sulfates, citrates, urea or mixtures thereof, as is sufficiently well known from the prior art. This can be done either directly after the product leaves the tower, in a mixer or else in a rounder. It is preferred to use solids, especially bicarbonates and soda, in amounts of up to 15% by weight and in particular in amounts of from 2 to 15% by weight, based in each case on the after-treated product.

In a preferred embodiment of the invention, the product has nonionic surfactants which may, for example, comprise optical brighteners and/or hydrotropes, perfume, a solution of optical brightener and/or foam inhibitors and/or supply forms which may comprise these ingredients. These ingredients or supply forms which comprise these ingredients are preferably applied to the product in liquid, molten or pasty form. Advantageously, the product portion(s) are after-treated with up to 20% by weight, advantageously with from 2 to 18% by weight and in particular with from 5 to 15% by weight of active substance of the ingredients mentioned. The amounts stated are based in each case on the after-treated product. It is preferred to effect the after-treatment with the substances mentioned here in a customary mixer, merely, for example, in a 2-shaft mixer within not more than 1 minute, preferably within 30 seconds and, for example, within 20 seconds, the times stated simultaneously representing addition time and mixing time. It is no surprise to the person skilled in the art that such measures can impair the flowability of the product.

The nonionic surfactants used are preferably alkoxylated, advantageously ethoxylated, in particular primary alcohols having preferably 8 to 18 carbon atoms and on average 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of natural origin having 12 to 18 carbon atoms, for example of coconut, palm, palm kernel, tallow fat or oleyl alcohol, and on average 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 7 EO. The degrees of ethoxylation specified are statistical average values which may be an integer or a fraction for a specific product.

Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 16 EO, 20 EO, 25 EO, 30 EO or 40 EO.

Further nonionic surfactants which may be used are also alkylglycosides of the general formula RO(G)ₓ in which R is a primary straight-chain or methyl-branched, in particular 2-methyl-branched, aliphatic radical having 8 to 22, preferably 12 to 18 carbon atoms, and G is the symbol which represents a glycose unit having 5 or 6 carbon atoms, preferably glucose. The degree of glycosidation x, which specifies the distribution of monoglycosides and oligoglycosides, is any number from 1 to 10; x is preferably from 1.1 to 1.4.

A further class of nonionic surfactants used with preference, which are used either as the sole nonionic surfactant or in combination with other nonionic surfactants, in particular together with alkoxylated fatty alcohols and/or alkylglycosides, is that of alkoxylated, preferably ethoxylated or ethoxylated and propoxylated, fatty acid alkyl esters, preferably having 1 to 4 carbon atoms in the alkyl chain, in particular fatty acid methyl esters, as described, for example, in the Japanese patent application JP 58/217598, or which are preferably prepared by the process described in the international patent application WO-A-90/13533. Particular preference is given to C₁₂-C₁₈ fatty acid methyl esters with on average from 3 to 15 EO, in particular with on average from 5 to 12 EO.

Nonionic surfactants of the amine oxide type, for example N-cocoalkyl-N,N-dimethylamine oxide and N-tallowalkyl-N,N-dihydroxyethylamine oxide, and of the fatty acid alkanolamide type may also be suitable. The amount of these nonionic surfactants is preferably not more than that of the ethoxylated fatty alcohols, in particular not more than half thereof.

For machine dishwashing, useful surfactants are in principle all surfactants. However, preference is given for this application to the above-described nonionic surfactants and here in particular to the low-foaming nonionic surfactants. Particular preference is given to the alkoxylated alcohols, particularly the ethoxylated and/or propoxylated alcohols. The person skilled in the art generally understands alkoxylated alcohols to mean the reaction products of alkylene oxide, preferably ethylene oxide, with alcohols, preferably in the context of the present invention the relatively long-chain alcohols (C₁₀ to C₁₈, preferably between C₁₂ and C₁₆, for example C₁, C₁₂, C₁₃, C₁₄, C₁₅, C₁₆, C₁₇ and C₁₈ alcohols). In general, n moles of ethylene oxide and one mole of alcohol, depending on the reaction conditions, form a complex mixture of addition products of different degrees of oxylation. A further embodiment consists in the use of mixtures of alkylene oxides, preferably of the mixture of ethylene oxide and propylene oxide. It is also possible if desired, by a final etherification with short-chain alkyl groups, preferably the butyl group, to obtain the substance class of the “capped” alcohol ethoxylates, which may likewise be used in the context of the invention. Very particular preference is given in the context of the present invention to highly ethoxylated fatty alcohols or mixtures thereof with end group-capped fatty alcohol ethoxylates.

Perfume oils and fragrances which can be used are individual odorant compounds, for example the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexyl propionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, □-isomethylionone and methyl cedryl ketone; the alcohols include anethol, citronellol, eugenol, geraniol, linalool, phenylethyl alcohol and terpineol; the hydrocarbons include primarily the terpenes such as limonene and pinene. However, preference is given to using mixtures of different odorants which together produce a pleasing fragrance note. Such perfume oils may also comprise natural odorant mixtures, as are available from plant sources, examples being pine oil, citrus oil, jasmine oil, patchouli oil, rose oil or ylang-ylang oil. Likewise suitable are muscatel, clary sage oil, camomile oil, oil of cloves, balm oil, mint oil, cinnamon leaf oil, lime blossom oil, juniper berry oil, vetiver oil, olibanum oil, galbanum oil and labdanum oil, and also orange blossom oil, neroli oil, orange peel oil and sandalwood oil.

Further conceivable additives are foam inhibitors, for example foam-inhibiting paraffin oil or foam-inhibiting silicone oil, for example dimethylpolysiloxane. It is also possible to use mixtures of these active ingredients. Useful room temperature solid additives include, especially for the foam-inhibiting active ingredients mentioned, paraffin waxes, silicas which may also be hydrophobized in a known manner, and bisamides derived from C₂₋₇ diamines and C₁₂₋₂₂ carboxylic acids.

Foam-inhibiting paraffin oils which can be used and may be in a blend with paraffin waxes generally constitute complex substance mixtures without a sharp melting point. For characterization, the melting range is customarily determined by differential thermoanalysis (DTA) as described in AThe Analyst@ 87 (1962), 420, and/or the solidification point. This refers to the temperature at which the paraffin is converted by slow cooling from the liquid to the solid state. Paraffins having less than 17 carbon atoms cannot be used in accordance with the invention; their fraction in the paraffin oil mixture should therefore be as low as possible and is preferably below the significantly measurable limit which can be measured with customary analytical methods, for example gas chromatography. Preference is given to using paraffins which solidify in the range of from 20° C. to 70° C. It should be noted that even paraffin wax mixtures which appear to be solid at room temperature can contain varying amounts of liquid paraffin oils. In the paraffin waxes which can be used in accordance with the invention, the liquid proportion at 40° C. is at a maximum without actually being 100% at this temperature. At 40° C., preferred paraffin wax mixtures have a liquid fraction of at least 50% by weight, in particular of from 55% by weight to 80% by weight, and, at 60° C., a liquid fraction of at least 90% by weight. This has the consequence that the paraffins are free-flowing and pumpable at temperatures down to at least 70° C., preferably down to at least 60° C. It should also be ensured that the paraffins contain a minimum amount of volatile fractions. Preferred paraffin waxes contain less than 1% by weight, in particular less than 0.5% by weight, of fractions evaporable at 110° C. and standard pressure. Paraffins which can be used in accordance with the invention may be purchased, for example, under the trade names Lunaflex® from Fuller and Deawax® from DEA Mineralöl AG.

The paraffin oils may comprise room temperature solid bisamides which derive from saturated fatty acids having from 12 to 22, preferably from 14 to 18 carbon atoms, and from alkylenediamines having from 2 to 7 carbon atoms. Suitable fatty acids are lauric acid, myristic acid, stearic acid, arachic acid and behenic acid and mixtures thereof, as are obtainable from natural fats or hardened oils such as tallow or hydrogenated palm oil. Suitable diamines are, for example, ethylenediamine, 1,3-propylenediamine, tetramethylenediamine, pentamethylenediamine, hexamethylenediamine, p-phenylenediamine and tolylenediamine. Preferred diamines are ethylenediamine and hexamethylenediamine. Particularly preferred bisamides are bismyristoylethylenediamine, bispalmitoylethylenediamine, bisstearoyl-ethylenediamine and mixtures thereof, and the corresponding derivatives of hexamethylenediamine.

In some embodiments of the invention, the foam inhibitors mentioned may be present in the products.

In a further embodiment of the invention, the product after-treated with the ingredients mentioned and optionally rounded may be after-treated with solids, preferably bicarbonate and/or soda, especially in amounts of from 2 to 15% by weight based on the after-treated product.

In a preferred embodiment, the inventive film-packaged products producible in accordance with the invention also have the advantage that the product portion(s) present are rapidly soluble.

The product portion and/or the above-described after-treated products may have further constituents of washing, care and/or cleaning products, especially being mixed with them. It is commonly known from the broad prior art which ingredients of washing or cleaning compositions and which raw materials are typically also added, such as bleaches based on per compounds, bleach activators and/or bleach catalysts, enzymes from the class of proteases, lipases and amylases; or bacteria strains or fungi, foam inhibitors in optionally granular and/or compounded form, perfumes, thermally sensitive dyes and the like, which are appropriately mixed with the compositions dried beforehand and optionally after-treated products.

The product may likewise have UV absorbers, which attach to the treated textiles and improve the photostability of the fibers and/or the photostability of the other formulation constituents. UV absorbers refer to organic substances (light protection filters) which are capable of absorbing ultraviolet rays and emitting the energy absorbed again in the form of longer-wavelength radiation, for example heat. Compounds which have these desired properties are, for example, the compounds and derivatives of benzophenone which have substituents in the 2- and/or 4-position and are effective by virtue of radiationless deactivation. Also suitable are substituted benzotriazoles, 3-phenyl-substituted acrylates (cinnamic acid derivatives), optionally having cyano groups in the 2-position, salicylates, organic nickel complexes and natural substances such as umbelliferone and endogenous urocanic acid. Of particular significance are biphenyl derivatives and in particular stilbene derivatives as are described in EP 0728749 A and are available commercially as Tinosorb® FD or Tinosorb® FR ex Ciba. UV-B absorbers include 3-benzylidenecamphor or 3-benzylidenenorcamphor and derivatives thereof, for example 3-(4-methylbenzylidene)camphor as described in EP 0693471 B1; 4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzmalonate; triazine derivatives, for example 2,4,6-trianilino(p-carbo-2′-ethyl-1′-hexyloxy)-1,3,5-triazine and Octyl Triazone as described in EP 0818450 A1, or Dioctyl Butamido Triazone (Uvasorb® HEB); propane-1,3-diones, for example 1-(4-tert-butylphenyl)-3-(4′-methoxyphenyl)propane-1,3-dione; ketotricyclo[5.2.1.0]decane derivatives as described in EP 0694521 B1. Also suitable are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, for example 4-(2-oxo-3-bornylidenemethyl)benzenesulfonic acid and 2-methyl-5-(2-oxo-3-bornylidene)sulfonic acid and salts thereof.

Useful typical UV-A filters are in particular derivatives of benzoylmethane, for example 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds, as described in DE 19712033 A1 (BASF). The UV-A and UV-B filters can of course also be used in mixtures. In addition to the soluble substances mentioned, insoluble light protection pigments are also useful for this purpose, specifically finely dispersed, preferably nanoized, metal oxides or salts. Examples of suitable metal oxides are in particular zinc oxide and titanium dioxide and additionally oxides of iron, zirconium, silicon, manganese, aluminum and cerium, and mixtures thereof. The salts used may be silicates (talc), barium sulfate or zinc stearate. The oxides and salts are already used in the form of pigments for skincare and skin-protection emulsions and decorative cosmetics. The particles should have an average diameter of less than 100 nm, preferably between 5 and 50 nm and in particular between 15 and 30 nm. They may have a spherical shape, although it is also possible to use particles which have an ellipsoidal shape or a shape which deviates in some other way from the spherical form. The pigments may also be surface-treated, i.e. hydrophilized or hydrophobized. Typical examples are coated titanium dioxides, for example titanium dioxide T 805 (Degussa) or Eusolex® T2000 (Merck). Useful hydrophobic coating compositions are in particular silicones and especially trialkoxyoctylsilanes or simethicones. Preference is given to using micronized zinc oxide. Further suitable UV light protection filters can be taken from the review of P. Finkel in SÖFW-Journal 122, 543 (1996).

The UV absorbers are used typically in amounts of from 0.01% by weight to 5% by weight, preferably of from 0.03% by weight to 1% by weight. In exceptional cases, they may even be present in the product.

However, other constituents, for example so-called sprinkles, which stand out from the appearance of the other components of the product by virtue of their color and/or their shape, may also be present in the product portion. The sprinkles may have a different color. It is equally possible that the sprinkles have the same composition as the other components of the product, are not colored but have a different shape. Ultimately, it is, though, preferred that sprinkles differ from the other components in color and, if appropriate, additionally in their shape. In these cases, the sprinkle should merely contribute to making the appearance of the finished washing, care and/or cleaning product even more attractive.

In a further and entirely preferred embodiment of the invention, however, the sprinkles have a different chemical composition to the other components present in the product. Specifically here, it is possible, on the basis of a different color and/or a different shape, to indicate to the consumer that certain ingredients for certain purposes, for example bleaching or care aspects, are present in the end product. These sprinkles may not only be spherical to rod-shaped, but may also have entirely different figures. At this point, reference is made to the disclosure of the international applications WO 97/08290 and WO 00/23556.

The added sprinkles or else other ingredients may, for example, be spray-dried, agglomerated, granulated, pelletized or extruded. With regard to extrusion processes, reference is made here in particular to the disclosures in the European patent EP 0486592 B1 and the international patent application WO 98/12299. Since a product having an outstanding dissolution rate is usable with preference even in relatively cold water at 30° C., it is of course preferred to add to it such further ingredients and/or raw materials which likewise have an outstanding dissolution rate. Therefore, in a preferred embodiment of the invention, raw materials which have been produced according to the disclosure of the international patent application WO 99/28433 are added to the film-packaged products.

The film-packaged product portion preferred in accordance with the invention may additionally have at least one component, preferably a plurality of components, selected from the group comprising, as washing-, care- and/or cleaning-active substances, anionic surfactants, cationic surfactants, amphoteric surfactants, nonionic surfactants, builder substances, bleaches, bleach activators, bleach stabilizers, bleach catalysts, enzymes, polymers, cobuilders, alkalizers, acidifiers, antiredeposition agents, silver protectants, colorants, optical brighteners, UV-protective substances, fabric softeners, perfume, foam inhibitors and/or rinse aids, and also any further constituents added.

The present invention further provides a process for producing an inventive film-packaged product portion, in which at least one film is plastically reshaped to form a container for the purpose of accommodating the product, the container preferably being formed in a pot-like manner.

Depending on the production, the product may be transferred vertically and/or horizontally, preferably horizontally, into the container, preferably into the plastically reshaped pot film.

The film container is preferably impervious after accommodating the product, preferably with formation of a film seam. It is preferred that the film container or the inventive film package is sealed such that the product present therein does not emerge in an unwanted manner prematurely, i.e. before use, for example actually during storage. When the film package comprises a liquid, the seam should be liquid-tight. In contrast, when the inventive film package comprises a solid, it is sufficient when the inventive film package is sealed such that the solid does not prematurely emerge from the film package.

A sealing film seam, preferably a circumferential sealing film seam, of the film package can be formed by means of pressure and/or moisture, preferably by means of contacting at least two films.

The film(s) suitable for producing the inventive film-packaged film package may have a certain tack, so that such a film or films can be bonded to one another by means of pressure and/or moisture. Correspondingly suitable films are, though, preferably nontacky at room temperature and at atmospheric humidity of less than 50% (RH).

Products film-packaged in accordance with the invention are usable as a laundry detergent, cleaning composition, care composition, hair treatment composition, hair dyeing composition, medicament, crop protection composition, food, cosmetic, fertilizer, building material, adhesive, bleach, disinfectant and/or fragrancing composition.

The inventive film package can be attacked by substances selected from the group below:
sodium bicarbonate,
sodium carbonate,
sodium hydroxide,
sodium metasilicate,
sodium orthosilicate,
potassium bicarbonate,
potassium carbonate,
potassium hydroxide,
potassium/sodium phosphates,
potassium/sodium orthophosphates and/or
compounds having a pH of no more than 5

Examples 1 to 3 below specify preferred product compositions which are suitable for filling an inventive film package.

### EXAMPLE 1

Solid product composition which, based on the total weight, has the following wash-active components:

10% by weight-15% by weight of alkylbenzenesulfonate;

0% by weight-5% by weight of nonionic surfactants;

12% by weight-16% by weight of bleaches;

0% by weight-5% by weight of tetraacetylethylenediamine (TAED);

1% by weight-5% by weight of zeolites;

0% by weight-9% by weight of silicates,

0.1% by weight-3% by weight of enzymes.

### EXAMPLE 2

Gel-form product composition which, based on the total weight, has the following wash-active components:

1% by weight-5% by weight of nonionic surfactants;

15% by weight-30% by weight of fatty alcohol exthoxylate (FAEO), nonionic surfactants;

5% by weight-10% by weight of fatty alcohol ethoxylate sulfate (FAEOS);

7% by weight-12% by weight of coconut-palm kernel oil fatty acid;

2% by weight-5% by weight of sodium hydroxide;

0.2% by weight-2% by weight of ethanol;

0.2% by weight-0.5% by weight of thickener;

3% by weight-8% by weight of glycerol;

0% by weight-2% by weight of boric acid;

0% by weight-5% by weight of citric acid;

0% by weight-5% by weight of sodium citrate 2H₂O;

remainder water.

Usually such products may also comprise enzymes, antifoams, complexing agents, brighteners, dyes and/or perfumes.

### EXAMPLE 3

Gel-form product composition which, based on the total weight, has the following wash-active components:

1% by weight-3% by weight of nonionic surfactants;

5% by weight-8% by weight of fatty alcohol exthoxylate (FAEO), nonionic surfactants;

2% by weight-7% by weight of fatty alcohol ethoxylate sulfate (FAEOS);

2% by weight-8% by weight of coconut-palm kernel oil fatty acid;

1% by weight-4% by weight of sodium hydroxide;

0% by weight-1% by weight of ethanol;

0.2% by weight-0.5% by weight of thickener;

3% by weight-8% by weight of glycerol;

0% by weight-2% by weight of boric acid;

0% by weight-5% by weight of citric acid;

0% by weight-5% by weight of sodium citrate 2H₂O;

remainder water.

Usually, such products may also comprise enzymes, antifoams, complexing agents, brighteners, dyes and/or perfume(s).

Standard Test Method for the Dissolution/Disintegration of Water-Soluble Film or Film Package

A film or a film package with or without contents is clamped in a clamping device, preferably a 35 mm slide frame.

A 600 ml beaker is filled with 500 ml of distilled water. The water is stirred by means of a 5 cm stirrer bar, the stirring rate being increased until a vortex forms which reaches a height of about one-fifth of the total water level. Subsequently, the temperature is adjusted to the predetermined value, for example 10° C. or 23° C.

The clamping device, for example slide frame, is preferably fixed by means of a crocodile clip and held thus in the beaker such that the long end of the clamping device is parallel to the water surface and the crocodile clip is about 0.6 cm below the water line. The clamping device is held such that, viewed from above, it extends roughly to the middle of the beaker.

Once the clamping device has been introduced into the beaker, first the time is measured until the film or the film package with or without contents tears. Secondly, the time is measured which is taken until the film or film package with or without contents has disintegrated into separate parts, and also the time until all film fragments have dissolved in the water.

After a maximum of 300 seconds, the test is terminated.

The test is repeated three times and subsequently averaged.

For a film usable in accordance with the invention, for example, a time of no more than 7 seconds that the film requires to tear in the slide frame was determined. In addition, for a film usable in accordance with the invention, for example, a time of no more than 70 seconds that the film requires to go into solution was determined, the clamping device used having been a slide frame.

IR Spectrometer

The IR spectrometer used for the analyses, unless stated otherwise, was: IFS 66 V from Bruker with a Golden Gate ATR unit from Specac (diamond crystal), applied pressure of the films=50 cNm.

1. A film-packaged product portion, comprising a package with at least two films, at least one of said films having at least one compartment for accommodating the product,
at least one of said films being alkali-stable and water-soluble and adapted to effect opening of said package when immersed in water, and
at least part of one of said films being substantially plastically reshaped for the purpose of accommodating the product.

2. A film-packaged product portion, comprising a package with at least one film having at least one compartment for accommodating the product,
said film being film being alkali-stable and water-soluble and adapted to effect opening of the package when immersed in water, and having a part substantially plastically reshaped to form said compartment,
when measured in distilled water at a water temperature of 10° C., said package having a shorter opening time than a similar package comprising a Mono-Sol M-8630 film packaged under otherwise identical conditions.

3. The film-packaged product portion as claimed in claim 2, wherein the opening time is the dissolution time of said at least one film.

4. The film-packaged product portion as claimed in claim 2, wherein the opening time is the disintegration time of said at least one film.

5. The film-packaged product portion as claimed in claim 1, including a washing, cleaning and/or care product portion within said compartment.

6. The film-packaged product portion as claimed in claim 2, said package having an opening time of not more than 14 seconds.

7. The film-packaged product portion as claimed in claim 1, in which, when the package is opened in an aqueous application liquor, the product is released into the liquor within not more than 50 seconds.

8. The film-packaged product portion as claimed in claim 1, in which the film of the package has a part which has been substantially reshaped and a part which has not been substantially reshaped, both parts being of the same film composition, wherein the substantially reshaped part has a shorter opening time than the part which has not been substantially plastically reshaped in the film packaging.

9. The film-packaged product portion as claimed in claim 1, wherein said at least one film, measured in distilled water at a water temperature of 10° C., has
a disintegration time of not more than 15 seconds, and
a dissolution time of not more than 30 seconds.

10. The film-packaged product portion as claimed in claim 1, in which the package has
at least one film lid part and at least one film pot part.

11. The film-packaged product portion as claimed in claim 1, in which the film packaging forms a container in which one of said films is substantially reshaped to accommodate the product, and another of said films has not been substantially plastically reshaped, and forms a lid, the one film being bonded in a liquid-tight manner to the other film, with at least one circumferential seam.

12. The film-packaged product portion as claimed in claim 1, in which said at least one film, based on the length of the corresponding starting film before said plastic reshaping, is substantially plastically reshaped to stretch by at least 50%.

13. The film-packaged product portion as claimed in claim 1, in which at least one outer surface of one of said two films has least one surface with longitudinally aligned structuring, the structural elements of the structuring in the form of a longitudinal depression having at least partly a length of from 20 μm to 100 μm and a width of from 5 μm to 30 μm.

14. The film-packaged product portion as claimed in claim 13, in which, over an area of 500 μm², there are at least 20 longitudinally aligned structural elements.

15. The film-packaged product portion as claimed in claim 1, in which one of said at least two films forms a lid part, and another of said at least two films forms a pot part, said parts having inner and outer surfaces, at least one surface of the film lid part, and at least one surface of the pot part have particles formed from film material, the particles at least partly having a particle size in the range from 1 μm to 20 μm.

16. The film-packaged product portion as claimed in claim 1, in which one of said at least two films forms a lid part, and another of said at least two films forms a pot part, at least one film being perforated, having holes, preferably having a diameter of from 1 μm to 50 μm.

17. The film-packaged product portion as claimed in claim 16, wherein said perforated film has an average at least one hole per mm² of film.

18. The film-packaged product portion as claimed in claim 1, comprising two separate films, the separate films being bonded in a liquid-tight manner by a circumferential seam to form a closed container.

19. The film-packaged product portion as claimed in claim 1, wherein at least one film, after full hydrolysis with potassium hydroxide, has:
from 0% by weight to 10% by weight of acetic acid, and
from 0% by weight to 20% by weight of glycerol, and
from 0% by weight to 10% by weight of sorbitol, and
from 0% by weight to 10% by weight of trimethylolpropane (TMP), and
from 0% by weight to 10% by weight of polyvinyl acetate.

20. The film-packaged product portion as claimed in claim 1, including a product in the compartment, said product has a form at room temperature selected from the group of solid, liquid, foam, and gel.

21. The film-packaged product portion as claimed in claim 20, wherein the product is in the form of a solid selected from the group of tablet, granule, capsule, and powder.

22. The film-packaged product portion as claimed in claim 1, including a product having a plurality of components selected from the group comprising, a washing-, care- and/or cleaning-active substance, anionic surfactants, cationic surfactants, amphoteric surfactants, nonionic surfactants, builder substances, bleaches, bleach activators, bleach stabilizers, bleach catalysts, enzymes, polymers, cobuilders, alkalizers, acidifiers, antiredeposition agents, silver protectants, colorants, optical brighteners, UV-protective substances, fabric softeners, perfume, foam inhibitors and rinse aids.

23. The film-packaged product portion as claimed in claim 1, wherein said at least one film has an elongated part having at least one of the IR spectra III to VIII.

24. The film-packaged product portion as claimed in claim 23, wherein said at least one film also has an unelongated part, said unelongated part being in the region of the outer edges and having at least one of the IR spectra III to IV.

25. A process for producing a film-packaged product portion comprising a package with at least two films, at least one of said films having at least one compartment for accommodating the product, at least one of said films being alkali-stable and water-soluble, and at least part of one of said films being substantially plastically reshaped for the purpose of accommodating the product, including the step of plastically reshaping the at least one film to form the compartment for the product.

26. A process for preparing a film-packaged product portion as claimed in claim 25, wherein the at least one film is substantially plastically reshaped by means of a thermoforming process.

27. A process for preparing a film-packaged product portion as claimed in claim 25, in which the product is loaded into the container, and the container, after accommodating the product, is sealed tightly with formation of a circumferential seam.

28. A process for preparing and using of the package as claimed in claim 27, wherein the product is selected from the group consisting of laundry detergent, cleaning composition, care composition, hair treatment composition, hair dyeing composition, medicament, crop protection composition, food, cosmetic, fertilizer, building material, adhesive, bleach, disinfectant and fragrancing composition, and including the step of immersing the package in water to release the product for use.

29. The film-packaged product portion as claimed in claim 1, in which said at least one film, after full hydrolysis with potassium hydroxide, is comprised of one or more of the following:
from 0% by weight to 10% by weight of acetic acid, or
from 0% by weight to 20% by weight of glycerol, or
from 0% by weight to 10% by weight of sorbitol, or
from 0% by weight to 10% by weight of trimethylolpropane (TMP), or
from 0% by weight to 10% by weight of polyvinyl acetate, or
combinations thereof.

30. The film-packaged product portion as claimed in claim 1, in which said at least one film comprises a polyvinyl alcohol whose molecular weight is in the range from 10 000 to 1 000 000 gmol⁻¹.

31. The film-packaged product portion as claimed in claim 30, in which said polyvinyl alcohol has a molecular weight in the range of from 40,000 to 80,000 gmol⁻¹.

32. The film-packaged product portion as claimed in claim 1, in which said at least one film comprises a polyvinyl alcohol whose degree of hydrolysis amounts to from 70 to 100 mol %.

33. The film-packaged product portion as claimed in claim 1, in which said at least one film comprises a polyvinyl alcohol whose degree of hydrolysis amounts to from 82 to 88 mol %.

34. The film-packaged product portion as claimed in claim 1, in which said at least one film has additive polymers selected from the group comprising acrylic acid-containing polymers, polyacrylamides, oxazoline polymers, polystyrenesulfonates, polyurethanes, polyesters, polyethers and mixtures of the above polymers.
